(19) United States
(12) Patent Application Publication
(10) Pub. No.: US 2023/0080698 A1
(43) Pub. Date: Mar. 16, 2023

(54) DATA-DRIVEN WORKPLACE WASTE REDUCTION APPROACH INVOLVING LIVE IN-BUILDING WASTE TRACKING, LIVE DATA ANALYTICS AND EMPLOYEE ENGAGEMENT PROGRAMS

(71) Applicant: Spareit, Inc., Belmont, MA (US)

(72) Inventors: Olivier De la Bastide, Paris (FR); Laurent Nicolas MEUNIER, Lexington, MA (US); CANNEVA Laurent, Belmont, MA (US)

(21) Appl. No.: 17/796,236

(22) PCT Filed: Jan. 25, 2021
(86) PCT No.: PCT/US2021/014961

§ 371 Date: Jul. 28, 2022

Related U.S. Application Data
(60) Provisional application No. 62/967,372, filed on Jan. 29, 2020.

(51) Int. Cl. G06Q 10/00; G06Q 10/06; G09B 19/00

(52) U.S. Cl. CPC G06Q 10/30; G06Q 10/063114; G09B 19/00

(57) ABSTRACT

A method and apparatus for interacting with users in collection and sorting of waste is provided. This includes providing one or more receptacle, one or more scale sensor associated with the one or more receptacle and configured, adapted, and positioned to measure weight, volume, or other characteristics of the one or more receptacle and its contents, a processor and communication port coupled with the scale sensor and communicatively coupled with a computer network, and an electronic dashboard that displays a quantity and quality of contents in the one or more receptacle and a status of a competitive challenge based on the quantity and quality of contents. The system manages one or more competitive challenges associated with users collecting and sorting waste based on the quantity and quality of contents in the one or more receptacle relative to one or more predetermined goals.

### CROSS-REFERENCE TO RELATED APPLICATION(S)

This application claims priority to, and the benefit of, co-pending U.S. Provisional Application 62/967,372, filed Jan. 29, 2020, for all subject matter common to both applications. The disclosure of said provisional application is hereby incorporated by reference in its entirety.

### FIELD OF THE INVENTION

The present invention relates to refuse or waste tracking or monitoring suitable for reducing waste. In particular, the present invention relates to a data-driven workplace waste reduction approach involving live in-building waste tracking, live data analytics and employee engagement programs

### BACKGROUND

Many companies target a reduction of the waste they generate through their operations, as part of their CSR goals. Conventional approaches to waste reduction in the office have focused on running various corporate initiatives (recycling, composting, training campaigns . . . ), sometimes involving employees and measuring the outcome quarterly or annually based on overall reports sent by waste haulers/managers. The conventional approaches experience a number of shortcomings. For example, data is usually provided at the level of a building, or sometimes several buildings, so it is difficult to know where the initiatives have been effective. In some instances, it is difficult to keep employees engaged as they don't see the results of their efforts before the end of the quarter/the end of the year. In many instances, there is little incentive for employees to meet the goals because of a disconnect between one small action and the cumulative actions of many.

### SUMMARY

There is a need to transform employees' mindset and behaviors around refuse or waste and leverage their energy to reduce the enterprise environmental impact, meet a company's strategic corporate social responsibility (CSR) goals, and create a culture of sustainability in the workplace.

Additionally, there is a need to provide detailed and frequent measures of the effectiveness of waste reduction programs within the building or organization as well as a mechanism for encouraging continued participation. One such approach is to “game-ify” the process by adding a competitive element in which the status is tracked or “scored” across multiple participants, (teams, buildings, companies or other organizations).

The present invention is directed toward further solutions to address these needs, in addition to having other desirable characteristics. Specifically, in accordance with example embodiments of the present invention, a system for interacting with users in collection and sorting of waste is provided. The system includes, one or more receptacle, one or more scale sensor, a processor and communication port, and an electronic dashboard. The one or more scale sensor is associated with the one or more receptacle and is configured, adapted, and positioned to measure weight, volume, or other characteristics of the one or more receptacle and its contents, the scale sensor outputting real-time data. The processor and communication port are coupled with the scale sensor and communicatively coupled with a computer network. The electronic dashboard displays a nature and quantity and/or quality of contents in the one or more receptacle based on the data in real-time and a status of a competitive challenge based on the nature and quantity of contents. The system manages one or more competitive challenges associated with users collecting and sorting refuse based on the quantity and/or quality (e.g. type of waste, contamination) of contents in the one or more receptacle relative to one or more predetermined goals.

In accordance with certain aspects of the present invention, the one or more receptacle includes at least one of: a trash receptacle, a recycling receptacle, a compost receptacle.

In accordance with certain aspects of the present invention, the scale sensor of the system measures weight between 0 and 200 pounds plus or minus 0.2 pounds.

In accordance with certain aspects of the present invention, the system automatically collects data at a configurable sampling rate.

In accordance with certain aspects of the present invention, the system is in communication with a wireless network.

In accordance with certain aspects of the present invention, the system is battery powered.

In accordance with certain aspects of the present invention, the system is remotely managed and controlled.

In accordance with certain aspects of the present invention, the system further includes a remote monitoring platform communicatively coupled to the computer network, the remote monitoring platform is configured to receive the real-time data from the scale sensor, analyze this data, and generate consolidated information in a display for the electronic dashboard. In some such aspects, the remote monitoring platform is further configured to process waste data to automatically propose reduction goals, detects areas of improvement, and propose reduction initiative; track the progress of reduction initiatives, combine waste data with other data coming from the building or facility (employee presence, energy, water, etc.) and generate reports.

In accordance with certain aspects of the present invention, the system is deployed across multiple locations each having one or more scale sensor associated with one or more receptacle at each location. In some such aspects, the multiple locations are within a facility. In other such aspects, the multiple locations are in multiple facilities or even multiple organizations (companies, universities, etc.). In such aspects, the one or more competitive challenges include competition between one or more other locations, groups of locations, other facilities, or even other organizations (companies, universities, etc.) that provides a ranking of the locations, groups, facilities, or organizations in relation to each other.

In accordance with certain aspects of the present invention, the status of a competitive challenge includes collection and sorting of waste over a time period. In some such aspects, the status of competitive challenge comprises comparison of collection and sorting of waste from different time periods.

In accordance with certain aspects of the present invention, the electronic dashboard further displays at least one of: games, quizzes, sorting advice, relevant news, competition results, and educational materials.

In accordance with certain aspects of the present invention, the system further identifies and delivers recommendations based on quantity and/or quality of contents.

In accordance with certain aspects of the present invention, the electronic dashboard is displayed on a display provided in proximity to the location of the one or more receptacles.

In accordance with certain aspects of the present invention, the electronic dashboard is displayed on a personal electronic device.

In accordance with certain aspects of the present invention, the system further includes one or more inputs or sensors for receiving a contamination evaluation. In some such aspects, the one or more sensors or inputs include a personal electronic device configured to receive a contamination evaluation.

In accordance with example embodiments of the present invention, a method for interacting with users in collection and sorting of waste is provided. The method includes providing one or more receptacle, providing one or more scale sensor, providing a processor and communication port, and providing an electronic dashboard. The one or more scale sensor is associated with the one or more receptacle and is configured, adapted, and positioned to measure weight, volume, or other characteristics of the one or more receptacle and its contents, the scale sensor outputting real-time data. The processor and communication port are coupled with the scale sensor and communicatively coupled with a computer network. The electronic dashboard displays a quantity and/or quality of contents in the one or more receptacle based on the t data in real-time and a status of a competitive challenge based on the quantity of contents. The system manages one or more competitive challenges associated with users collecting and sorting waste based on the quantity of contents in the one or more receptacle relative to one or more predetermined goals.

In accordance with certain aspects of the present invention, the method further includes providing a remote monitoring platform. The remote monitoring platform is communicatively coupled to the computer network, the remote monitoring platform configured to receive the real-time data from the scale sensor, analyze this data, and generate consolidated information in a display for the electronic dashboard. In certain such aspects, the method further includes proposing reduction goals, detecting areas of improvement, and proposing reduction initiatives; tracking the progress of reduction initiatives, combining waste data with other data coming from the building or facility (employee presence, energy, water, etc.), and generating reports based on the data received from scale sensors.

In accordance with certain aspects of the present invention, the method further includes providing multiple scale sensors wherein each scale sensor is associated with one or more receptacle at multiple locations. Also, in some such aspects, the multiple locations are within a facility. In other such aspects, the multiple locations are in multiple facilities or multiple organizations (companies, universities, etc.) In some such aspects, the one or more competitive challenges comprises competition against one or more other locations, groups, facilities, or organizations.

In accordance with certain aspects of the present invention the method further includes receiving a contamination evaluation. In some such aspects, the contamination evaluation is received from a personal electronic device.

In accordance with example embodiments of the present invention, a method of interacting with users in collection and sorting of refuse is provided. The method includes, tracking waste collected at one or more receptacle deployed at one or more locations in real-time and providing an electronic dashboard. The electronic dashboard displays a quantity and/or quality of contents in the one or more receptacle and a status of a competitive challenge based on the quantity of contents.

In accordance with certain aspects of the present invention, the tracking of waste collected is performed by one or more scale sensor associated with the one or more receptacle.

In accordance with certain aspects of the present invention, the tracking of waste collected comprises receiving a contamination evaluation. In some such aspects, the contamination evaluation is received from a personal electronic device.

In accordance with certain aspects of the present invention, providing an electric dashboard includes sending data regarding the tracked waste to a remote monitoring platform. The remote monitoring platform is configured to receive the real-time data and generating a display for the electronic dashboard based on received data.

In accordance with certain aspects of the present invention, the refuse collected is tracked at multiple locations. In such aspects, the one or more competitive challenges includes competition against one or more other locations. The multiple locations can be within a facility or in multiple facilities.

### BRIEF DESCRIPTION OF THE FIGURES

These and other characteristics of the present invention will be more fully understood by reference to the following detailed description in conjunction with the attached drawings, in which:

FIG. 1 is a diagram illustrating the philosophy and principles being addressed by the systems and methodologies of the present invention;

FIG. 2 depicts an example system deployed at a location in a facility in accordance with embodiments of the present invention;

FIG. 3 depicts an example scale sensor and receptacle in accordance with aspects of the present invention;

FIG. 4 depicts the underside of a scale sensor in accordance with aspects of the present invention;

FIG. 5 depicts the hardware of a scale sensor in accordance with aspects of the present invention;

FIG. 6 depicts an example methodology for receiving contamination evaluations in accordance with aspects of the present invention;

FIG. 7 is a diagram of a system for tracking waste at multiple locations in accordance with aspects of the present invention;

FIG. 8 depicts an example electronic dashboard in accordance with aspects of the present invention;

FIG. 9 depicts another example electronic dashboard in accordance with aspects of the present invention;

FIG. 10 depicts an example education seminar proving waste reduction recommendations in accordance with aspects of the present invention;

FIG. 11 depicts an example waste reduction recommendation comprising a reusable cutlery give-away in accordance with aspects of the present invention;

FIG. 12 depicts an example waste reduction recommendation comprising a newsletter in accordance with aspects of the present invention;

FIG. 13 depicts a high-level flow diagram of a methodology for interacting with users in the collection and sorting of waste in accordance with embodiments of the present invention;

FIG. 14 depicts an example methodology for implementing the methodology of FIG. 13 using the hardware and features of the system of the present invention in accordance with aspects of the present invention; and

FIG. 15 is a high-level system diagram of an electronic device used to implement functionality of the present invention in accordance with embodiments of the present invention.

### DETAILED DESCRIPTION

Illustrative embodiments of the present invention relate to a data-driven workplace waste reduction approach involving live in-building waste tracking, live data analytics, and employee engagement programs.

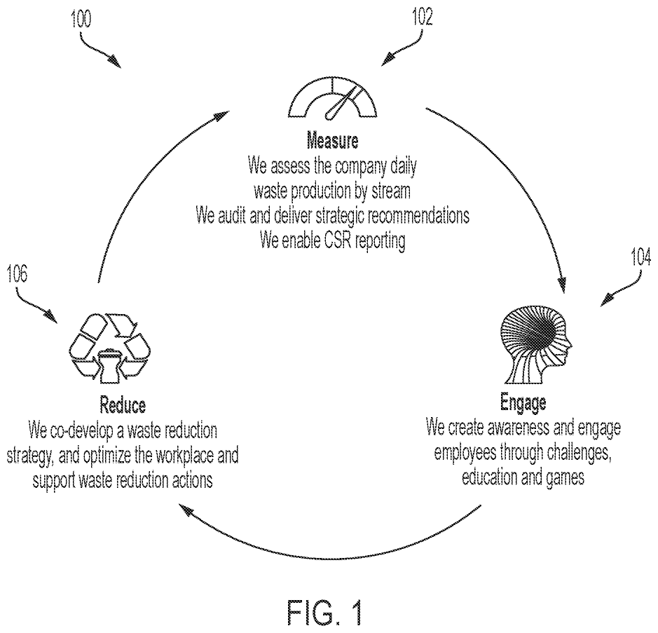

FIGS. 1 through 15 wherein like parts are designated by like reference numerals throughout, illustrate an example embodiment or embodiments of a system and methods for interacting with users in the collection and sorting of waste. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 is a diagram 100 showing the key parts of the philosophy and principles being addressed by the systems and methodologies of the present invention. To transform the employees' mindset and behaviors around waste, an original approach leveraging live waste data measured within the workplace is provided. The approach consists of three main elements: Measure 102, Engage 104, and Reduce 106.

To affect Measure 102, a proprietary system 200 for interacting with users in the collection and sorting of waste is provided that automatically tracks the daily amount of waste generated at a location, such as within the building. Live data is displayed to users, such as employees to create awareness.

To affect Engage 104, the live waste data is leveraged, and user engagement programs are organized to motivate users to reduce waste. Such user engagement programs include pledges, games, challenges and competitions.

To affect Reduce 106, specific waste reduction initiatives are recommended and supported to be executed with the users. The impact of those initiatives is tracked through the waste tracking system.

Using on this approach, users have been able to implement strong waste reduction (typically trash down by 50%, a significant improvement on diversion, lower contamination) with significant employee engagement (around 80%). A similar approach can be applied to other sustainability goals requiring user involvement (reducing energy use, changing commuting habits etc.).

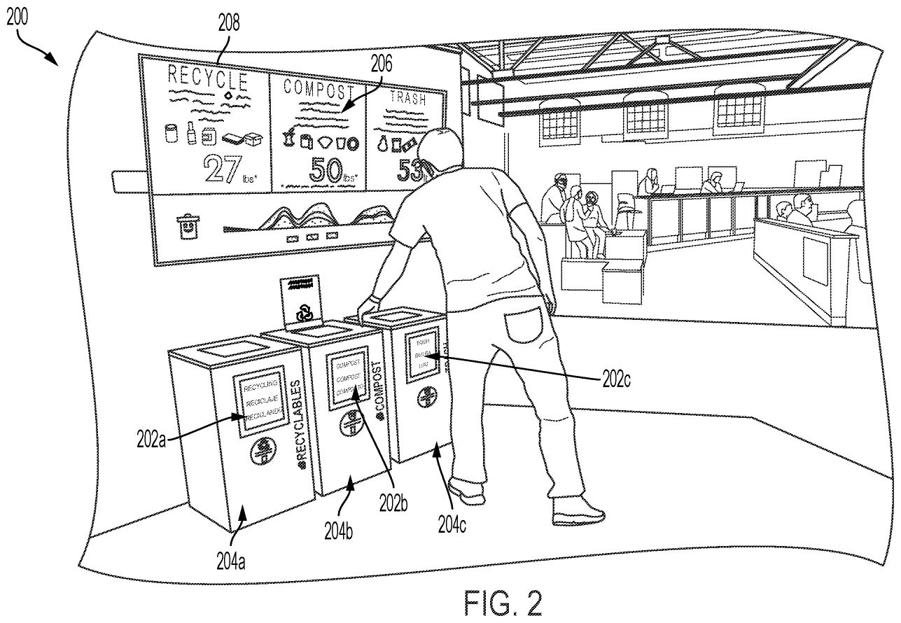

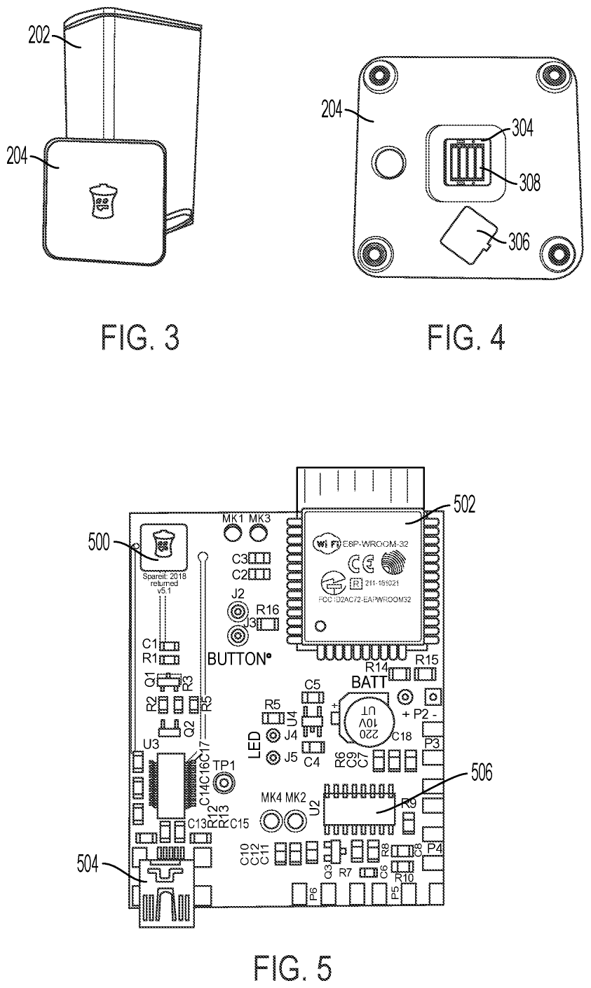

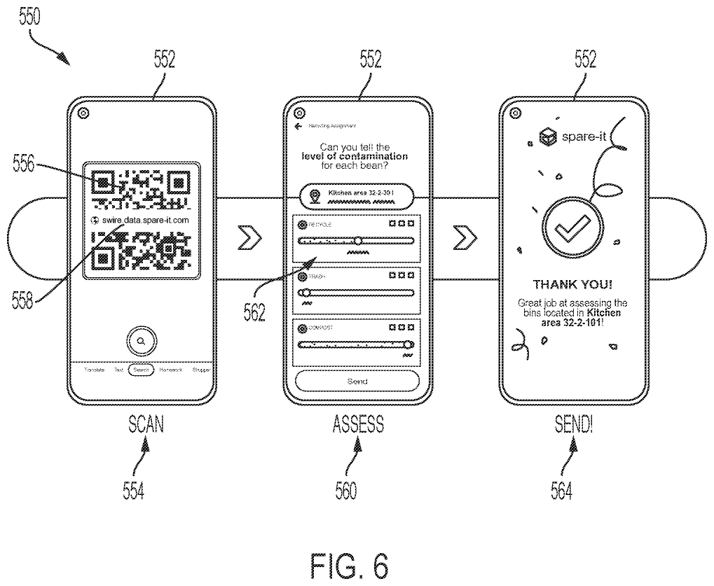

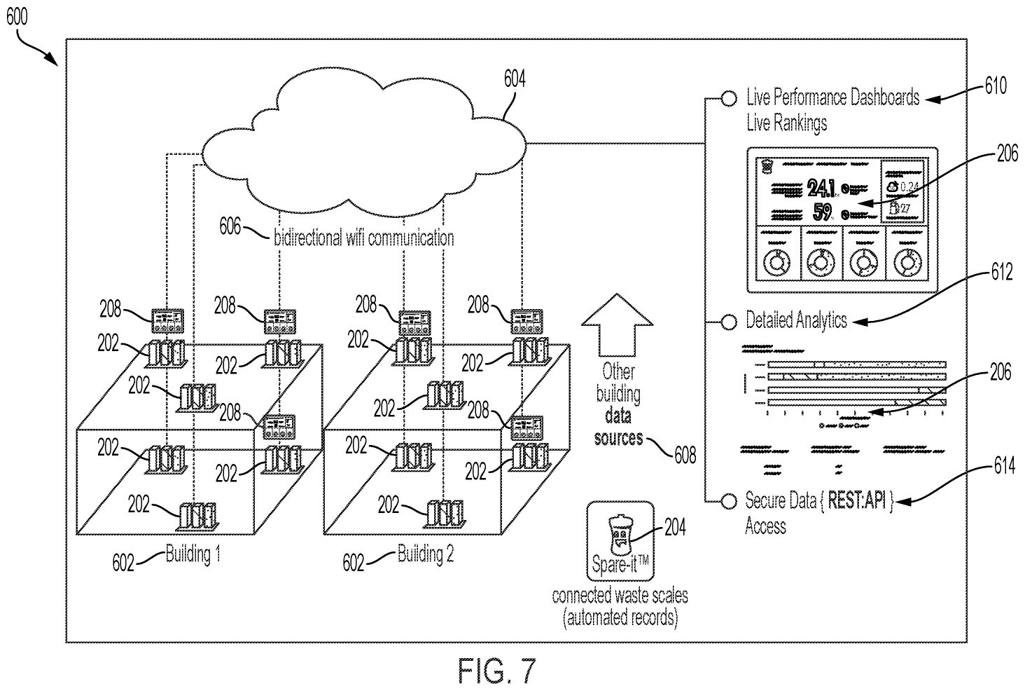

FIG. 2 through FIG. 7 depict the system 200 and the various components of the system 200 in accordance with various embodiments. FIG. 2 depicts the example system 200 deployed at a location in a facility in accordance with one embodiment. FIGS. 3-5 depicts an example of a receptacle, scale sensor, processor and communication port in accordance with one embodiment. FIG. 6 and FIG. 7 depict various embodiments of an electronic dashboard in accordance with various embodiments.

In the example of FIG. 2 the system 200 for interacting with users in the collection and sorting of waste has been deployed at a location. The system 200 includes one or more receptacle 202, one or more scale sensors 204 associated with the one or more receptacle 202, and an electronic dashboard 206. In this example the one or more receptacle 202 includes a recyclable receptacle 202a, a compost receptacle 202b, and a trash receptacle 202c. It should be understood that other configurations are possible. For example, there can be only one receptacle provided, which can be designated a single type waste or all waste types. Alternatively, there can be receptacles for different types of recyclables (e.g. metal, plastic, paper, etc.) or waste. Other possible configuration will be apparent to one skilled in the art given the benefit of this disclosure.

In the example of FIG. 2, each of the one or more receptacles 202a, 202b, 202c is has a scale sensor 204a, 204b, 204c associated with it which is positioned at the bottom of the respective receptacle 202a, 202b, 202c and configured to measure the weight, volume, or other characteristics of the one or more receptacles 202a, 202b, 202c and its contents. It should be understood, that a single scale sensor 204 can be used for all the receptacles 202 at a location or a subset of the receptacles 202 at the location. Other possible configuration will be apparent to one skilled in the art given the benefit of this disclosure.

In this embodiment, a processor and communication port (not shown—but well-understood by those of ordinary skill in the art) is associated with each of the scale sensors 204a, 204b, 204c. The processor and communication port may be incorporated as part of the scale sensor 204 or can be provide as part of a remote monitoring device or system that is in communication with the scale sensor(s) 204. It should be understood, that a single processor and/or communication port can be used for all the scale sensor 204 at a location or a subset of the receptacles 202 at the location. Similarly, multiple processors and/or communication ports can be provided for each scale sensor 204. Other possible configuration will be apparent to one skilled in the art given the benefit of this disclosure. Further discussion of the scale sensor 204 and processor and communication port can be found in the discussion of FIGS. 3-5.

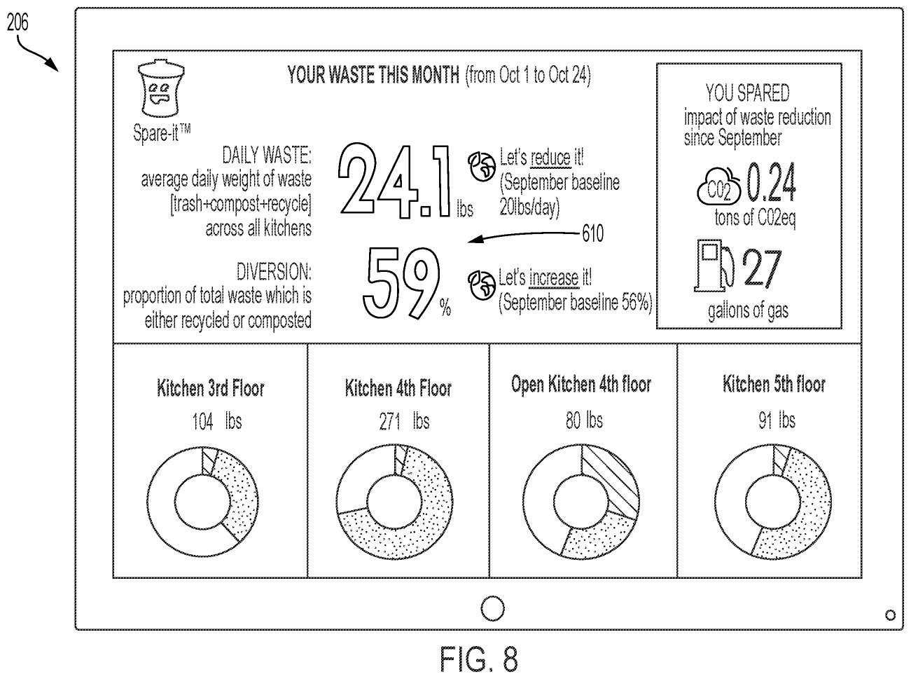

The last component of the system 200, is the electronic dashboard 206. The electronic dashboard 206 displays, among other things, a quantity and/or quality of contents in the one or more receptacle based on the data received from the scale sensor 204 in real time, and a status of a competitive challenge associated with the users collecting and sorting the waste based on the quantity or nature of contents in the one or more receptacles relative to one or more predetermined goals. In the example of FIG. 2, the electronic dashboard 206 is output or otherwise displayed on a display 208 located in proximity to the one or more receptacles 202a, 202b, 202c and displays information about the recycling, compost, and trash collected in the receptacles 202a, 202b, 202c. In other embodiments, the electronic dashboard can be output or otherwise displayed on a display 208 located remote from one or more receptacles 202a, 202b, 202c. For example, the electronic dashboard can be displayed in a breakroom, cafeteria, or facilities office. In still other embodiments, the electronic dashboard can be displayed on a personal electronic device such as a smartphone, tablet, or personal computer. Further discussion of the electronic dashboard 206 can be found in the discussion of FIG. 7 and FIG. 8.

FIGS. 3-5 depicts an example of a receptacle, scale sensor, processor and communication port in accordance with one embodiment. FIG. 3 depicts and receptacle 202 and scale sensor 204 as used in the system 200 of FIG. 2. FIG. 4 shows the underside of the scale sensor 204 of FIG. 3. FIG. 5 depicts a printed circuit board (PCB) used in the scale sensor 204 of FIG. 3 and FIG. 4 to provide the functionality of the scale sensor 204.

The one or more receptacle 202 can be any type or size of container or bin that can be used for receiving and collecting waste including recycling, compost, and trash. In this example, a scale sensor 204 sensor is associated with each receptacle 202. Here, the scale sensor 204 is configured, adapted, and positioned to measure weight of the one or more receptacle 202 and its content. In other embodiments, other types of sensors can be utilized. Examples of other such sensors include ultrasonic sensors to detect fill level of receptacle, infrared sensors to detect presence at receptacle, chemical sensors to detect composition of waste, cameras to perform object recognition, or any combination thereof. Other possibilities will be apparent to one skilled in the art given the benefit of this disclosure. The scale sensor 204 outputs real-time t data. The scale sensors 204 used the present example have been custom designed to provide automated tracking of waste for receptacles.

FIG. 4 shows the underside of the scale sensor 204. Here, a battery compartment 304 can be seen with the battery cover 306 removed giving a user access to the batteries 308 used to power the scale sensor 204. The functionality of the scale sensor 204 is provided by a proprietary printed circuit board (PCB) 500 as seen in FIG. 5.

The PCB 500 of FIG. 5 includes a processor 502 and a communication port 504 which are communicatively connected to a computer network. The processor 502 is configured to perform instruction that provide the functionality of the scale sensor 204. In this example, the processor 502 further provides wireless connectivity to computer networks including Wi-Fi™ and Bluetooth®, or other wireless communication protocol, connectivity. In certain embodiments, the processor 502 can be configured or otherwise adapted to provide further processing of the collected data. In some such embodiments, the processor 502 may be capable of generating the electronic dashboard 206. The communication port 504 provides a means of transferring data to and from the device through a wired connection. In this example, the communication port 504 is a universal serial (USB) port that may also provide power. In other embodiments, the communication port can be an ethernet port or a serial port. The PCB 500 also includes an analog to digital converter 506 and a four load cells (not shown—but well understood by those of ordinary skill in the art) for obtaining weight measurements. The particular configuration shown in FIGS. 3-5 allows the scale sensor 204 to provide weight measure in a range of 0-200 lbs. (0-90.7 kg), with a precision of 0.2 lb. (0.09 kg), automated measures with configurable sampling rate between 30 seconds and 2 hours, Wi-Fi™ network communication, scale setup via Bluetooth®, Over the air firmware update, battery powered or plugged power, low energy consumption (4 to 6 month autonomy on batteries) and remote control and monitoring.

It should be understood that other configurations and functionality are possible. Further evolutions of this system 200 can include additional inputs or sensors, for example to detect or receive indication of the fill level of the receptacle, or to automatically detect or receive indication of content of the receptacle (evaluation of contamination). As discussed, such inputs or sensors include, but are not limited to, ultrasonic sensors to detect fill level of receptacle, infrared sensors to detect presence at receptacle, chemical sensors to detect composition of waste, cameras to perform object recognition, touch screens, keypads, or buttons for receiving user input or any combination thereof.

In one such embodiment as seen in FIG. 6, a personal electronic device 552 such as a mobile phone, or tablet can be leveraged to make use of the technology incorporated into the personal electronic device 552 to provide a contamination evaluation 550. In methodology of the contamination evaluation 550 shown in FIG. 6 the first phase 554 is using the personal electronic device 552 to scan a code, such as a QR code 556, provided on, or in proximity to, the one or more receptacles 202 of the system 200. In this example, scanning the QR 556 code brings up a website 558 or application on the personal electronic device 552. In the next phase 560 of the contamination evaluation 550, the website 608 or application provides an input mechanism, in this case sliders 562, that allow a user to input a contamination evaluation for the one or more receptacles. In certain embodiments, a user can also input photographs (taken using a camera of the personal electronic device 552) in support of the contamination evaluation. Once the contamination evaluation has been entered it can be submitted using the website 558 or application as shown in the final phase 564. The provided contamination evaluation can then be provided to the appropriate scale sensor 204, electronic dashboard 206 or remote monitoring platform 604. In some embodiments, rewards or other benefits can be provided for submitting a contamination evaluation. Other possible configurations and functionality will be apparent to one skilled in the art given the benefit of this disclosure.

One aspect of the present invention is its scalability. That is, multiple locations can be monitored by providing one or more receptacles 202 as well as one or more scale sensors 204 (and their related hardware) at multiple locations. An example of this can be seen in FIG. 7.

In the multiple location system 600 of FIG. 7 one or more receptacles 202 are deployed at multiple locations across multiple floors, in multiples facilities 602. In this example, each location has the three receptacles as discussed in relation in FIG. 2. Each receptacle 202 also has a scale sensor 204 associated with it. Some of the locations also have a display 208 for displaying the electronic dashboard 206. One way of making this scalability possible is a remote monitoring platform 604 that is communicatively coupled to the same computer network as each of the scale sensors 204. In this example, the computer network is a bidirectional wireless communication network 606.

The remote monitoring platform 604 serves to enable the remote control and monitoring of each scale sensor 204 and related hardware, provide analysis of the data collected by each scale sensor 204, and generate the electronic dashboard 206. The remote monitoring platform 604 can be implemented by hardware and software on one or more servers, connected devices, or other cloud-based systems, including combinations of hardware and software. In certain other embodiments the functionality of the remote monitoring platform 604 can be implemented on hardware and software provided in one or more of the scale sensors 204.

In facilitating the remote control and monitoring of each scale sensor 204 and related hardware (such as processor 502), the remote monitoring platform 604 provides for: the management of customer accounts and scale allocation, the mapping of scale sensors with building or facilities structure and waste stream, scale remote control (activate/deactivate/configure) and monitoring, scale data collection (waste weight, time, battery level), and notifications (loss of connection, low battery, errors, inconsistent measures, etc.). In certain embodiments, the remote monitoring platform 604 is configured to receive other building data sources 608, such as temperature control, water consumption, power consumption, and building occupancy data to be included in the monitoring provided by the system 600.

In providing analysis of the data collected by each scale sensor 204 (and in some embodiments, from other building sources), the remote monitoring platform 604 enables the sharing of detailed waste analytics with users (such as students, employees and management) in a clear and engaging way. This functionality includes: data aggregation (live data from scales, other data sources like employee presence tracking) 610, waste data analytics (e.g., accumulated waste flow per day and per area, evolution over time) 612, providing such information in online dynamic dashboards advanced visualizations on the electronic dashboard 206, and secured data access API 614 for integration with other systems.

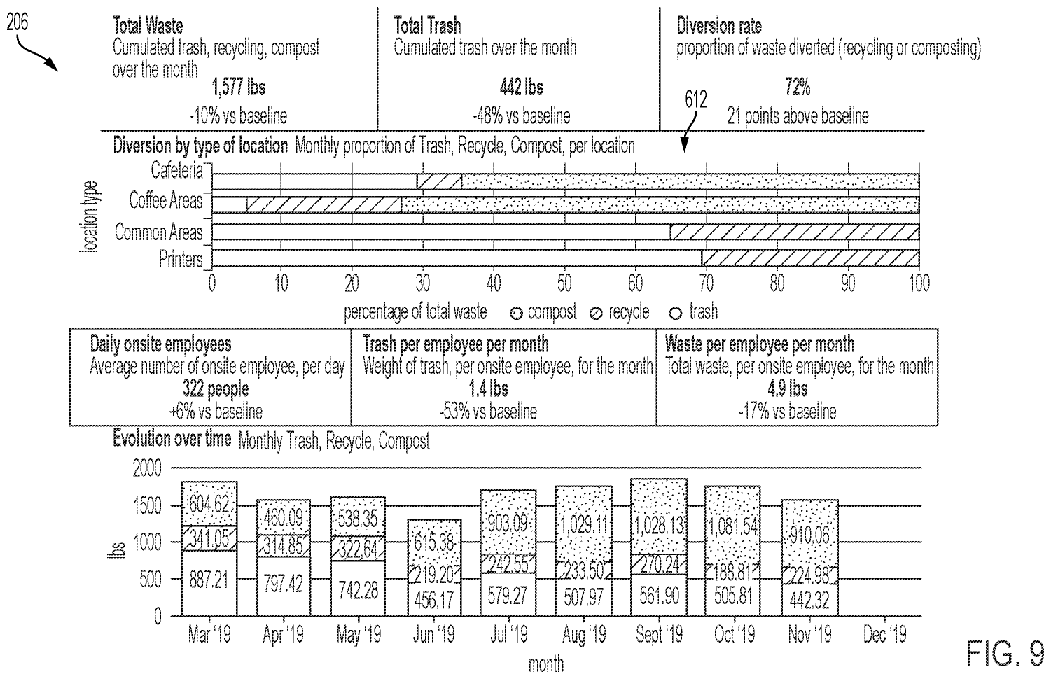

As mentioned previously, the remote monitoring platform 604 also generates the electronic dashboards 206 or other reports that can be provided to users. The electronic dashboard 206 displays, among other things, a quantity and/or quality and nature of contents in the one or more receptacle based on the data in real time, and a status of a competitive challenge associated with the users collecting and sorting the waste based on the quantity and/or quality of contents in the one or more receptacles relative to one or more predetermined goals. FIG. 8 and FIG. 9 provide examples of electronic dashboards 206 generated by the remote monitoring platform 604 and provided with the system 200.

FIG. 8 is an example of an electronic dashboard 206 providing live performance data and rankings 610. This live performance data and ranking 610 shows how much waste was collected at each of the locations being tracked as well as the daily average, the diversion percentage, and the benefits of such efforts. This can further include rankings of the measured performance including comparisons with other locations, groups, facilities, or, organizations. In certain embodiments, the electronic dashboard 206 can include additional games, information, or trivia to further improve engagement.

FIG. 9 is an example of an electronic dashboard 206 providing analytics 612. The analytics 612 show a breakdown of the total waste, total trash, and diversion rate and diversion by location. The analytics 612 also show a breakdown of per employee and over time.

The electronic dashboards 206 as seen in FIG. 8 and FIG. 9 can provide: current status of the waste flow in the workplace, challenge progress and competition rankings, games, trivia, and tips and advice on how to improve. As mentioned previously, the electronic dashboard 206 can be displayed on a hardware supported display 208 located in proximity to the receptacles being monitored or a display located at a monitoring location (such as a break room, cafeteria, or facilities office). In certain embodiments the electronic dashboard can be displayed on a hardware display 208 that is embodied in a personal electronic device, such as a smart phone, tablet, or personal computer connected to the network. In certain embodiments, the system can allow users to interact with the dashboard, to get assistance in waste sorting for example.

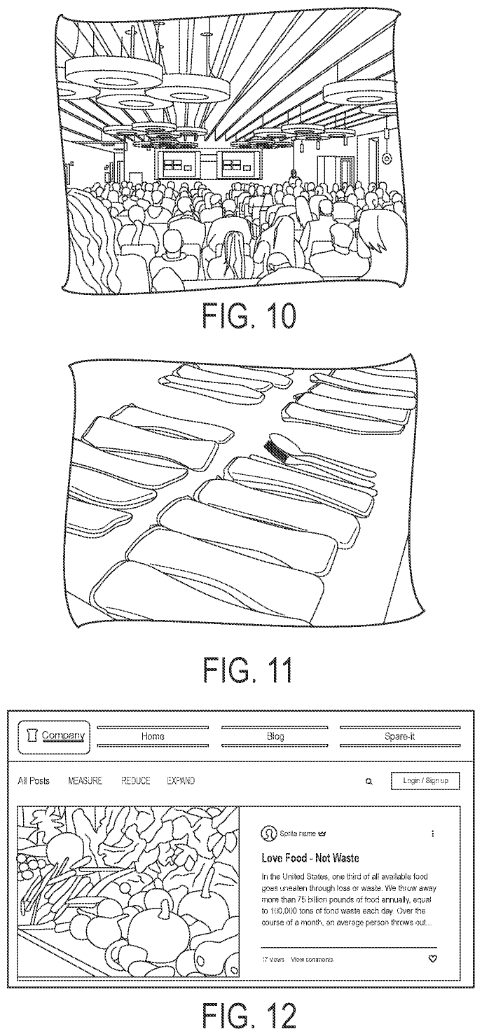

While the electronic dashboard provides feedback and engagement concerning the collection and sorting of waste through the tracking and ranking of performance, user engagement and performance can further be improved by providing reduction analysis and creating additional reduction recommendations. In some embodiments, this reduction analysis can include identifying reduction goals based on the quantity and/or quality of tracked waste, which can in turn be used to generate reduction recommendations. These reduction goals and recommendations can be electronically provided information provided either on the dashboard 206 or in a separate provided newsletter. In other embodiments, the recommendations can take the form of user engagement events or waste reductions initiatives that are crafted or otherwise designed based on the collected tracked waste data. Examples of such reduction recommendations can be seen in FIGS. 10-12.

FIG. 10 depicts a user engagement event wherein a presentation is generated and presented to the employees of a company using the waste tracking system of the present invention. FIG. 11 depicts a waste reduction initiative in which reusable cutlery sets were distributed to reduce the use of disposable cutlery that typically ends up in a waste receptacle. FIG. 12 depicts and online training blog with a monthly waste reduction focus.

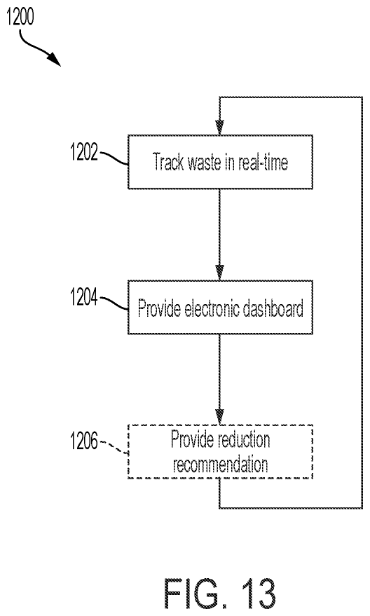

FIG. 13 depicts a high-level flow diagram 1200 of a process for interacting with users in the collection and sorting of waste. The method includes tracking waste collected at one or more receptacle deployed at one or more location in real-time (step 1202), and providing an electronic dashboard (step 1204), wherein the electronic dashboard displays a quantity and/or quality of waste collected being tracked and a status of a competitive challenge based on quantity of waste collected. In certain embodiments, the method may further include the step of providing recommendations based on the quantity and/or quality of waste collected (step 1206).

In certain embodiments, the tracking of waste collected (step 1202) is performed by one or more scale sensors 204 associated with one or more receptacle 202. In embodiments, where there are multiple locations, wherein each location has one or more receptacles 202, one or more scale sensors 204 may be associated with the one or more additional receptacles. In other embodiments, the tracking or waste may be performed by other means, such as sensors on or near the opening of the one or more receptacle 202 that detect when an item is places in the one or more receptacle. Still other embodiments can use an electric log system wherein users log the items placed in the one or more receptacle.

Providing the electronic dashboard (Step 1204) can be performed by the hardware or software provided by the same hardware and software used to track waste or can be provided by remote hardware or software in communication with the implemented tracking mechanism such as the remote monitoring platform discussed previously. The provided electronic dashboard is the electronic dashboard 206 discussed previously and can be displayed in the manner discussed above including on a provided display or on a personal electronic device. As discussed previously, in embodiments having multiple locations, the status of collection and competitive challenges provided by the electronic dashboard can include the data obtained from the other locations being tracked. In certain embodiments, the electronic dashboard may further include additional games, trivia, or information.

The process of the flow diagram 1200 then loops, as the waste is continuously being tracked (step 1202). Ideally, the tracked waste data and status of competitive challenges (as well any additional games, trivia, or information) displayed as part of the electronic dashboard increases user engagement and has a positive impact on the collection and sorting efforts being tracked creating a positive feedback loop.

In certain embodiments, the impact on collection and sorting efforts being tracked (step 1202), analyzed, ranked, and displayed in the electronic dashboard (step 1204) can further be improved by providing reduction recommendations (step 1206). Providing reduction recommendations (step 1206) includes identifying reduction goals and generating recommendations based on the quantity and/or quality of refuse being tracked. This can be performed by the hardware or software provided by the same hardware and software used to track waste or can be provided by remote hardware or software in communication with the implemented tracking mechanism such as the remote monitoring platform discussed previously. The identified reduction goals can be included in the analysis, ranking, and display provided in the electronic dashboard 206. The generated reduction recommendations can include any of the recommendations discussed above regarding FIGS. 10-12 or as part of the information provided on the electronic dashboard 206.

This process of the flow diagram 1200 set forth in FIG. 13 is designed to intentionally mirror or otherwise reflect the philosophy 100 set forth and discussed in relation to FIG. 1 wherein the tracking of waste (step 1202) of FIG. 13 correlates to Measure 102 element of FIG. 1, the providing of an electric dashboard (step 1204) of FIG. 13 correlates to the Engage 104 element of FIG. 1, and providing reduction recommendations (step 1206) of FIG. 13 correlates to the Reduction 106 element of FIG. 1.

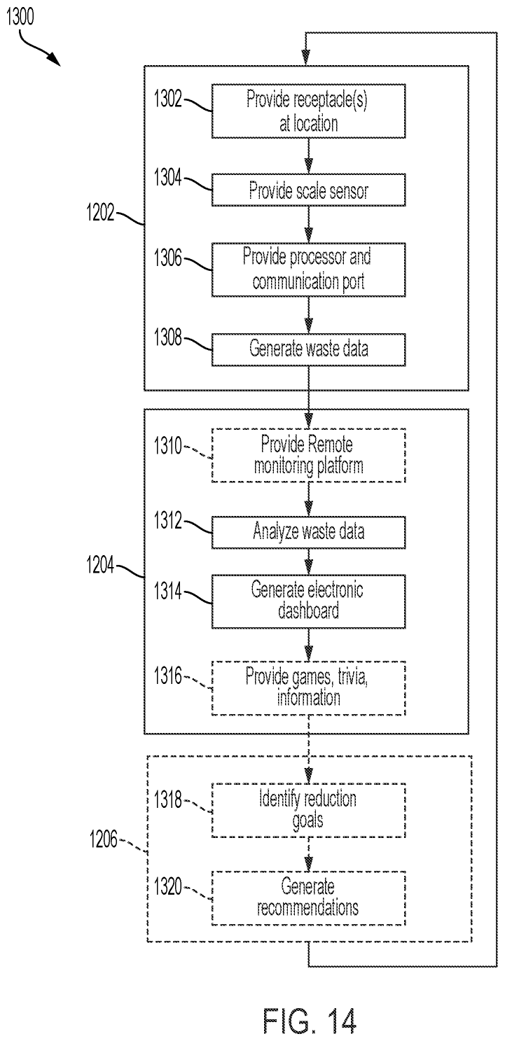

FIG. 14 depicts an example methodology 1300 for implementing the process of the flow diagram 1200 of FIG. 13 using the hardware and features of the system 200 depicted and discussed in relation to FIGS. 2-12. In this example, to track the waste collected (step 1202) one or more receptacle 202 are provided at least a first location (step 1302). In embodiments where multiple locations are tracked, one or more receptacle may be provided at each location being tracked.

A scale sensor 204 associated with the one or more receptacle being tracked is also provided (step 1304). In embodiments where multiple locations are tracked, additional scale sensors 204, each associated with the one or more receptacle provided at each location being tracked, can be provided.

A processor 502 and communication port 504 may be provided as part of the scale sensor(s) 204 or in separate hardware as discussed above (step 1306).

The provided scale sensor 204 (as well as processor 502 and communication port 504) generate waste including weight, volume, or other characteristic of the waste being tracked (step 1308).

The steps of providing receptacles 202 (step 1302), providing scale sensors 204 (step 1304), providing a processor 502 and communication port 504 (step 1306), and generating waste data (step 1308) correspond to the step of tracking waste data (step 1202) in FIG. 13.

In certain embodiments, a remote monitoring platform 604 may also be provided (step 1310). The remote monitoring platform 604, as previously discussed, can be used to configure, monitor, and analyze the data obtained from any scale sensor 204 being used in the system 200 (step 1312) and generate the electronic dashboard 206 (step 1314)

The analysis of waste data (step 1312) includes the computing of waste collection totals and the ranking in competitive challenges. In embodiments having multiple locations, the analysis can include waste data from the multiple locations. In certain embodiments, additional data (such as building data or reduction goals) may also be analyzed in conjunction with the weight data. In embodiments without a remote monitoring platform 604, the analysis of weight data (step 1312) can be performed in scale sensor 204, processor 502, or other hardware and software provided as part of the system.

An electronic dashboard 206, as discussed previously, is provided (step 1314). The electronic dashboard 206 displays a quantity and/or quality of contents based on the weight data in real time and a status of a competitive challenge based on the quantity of contents as discussed previously. In embodiments without a remote monitoring platform 604, The generation of the electronic dashboard (step 1314) can be performed may be performed in scale sensor 204, processor 502, or other hardware and software provided as part of the system.

In certain embodiments, to further enhance user engagement, the electronic dashboard 206 may further provide additional games, challenges, trivia, and information (step 1316) in addition to the quantity and/or quality of waste based on the waste data in real time and a status of a competitive challenge based on the quantity of contents as discussed previously.

The steps of providing a remote monitoring platform (step 1310), analyzing waste data (step 1312), generating the electric dashboard (step 1314), and providing additional games, trivia, and information correspond to the step of providing an electric dashboard (step 1204) in FIG. 13.

In certain embodiments, the methodology 1300 of FIG. 14, further includes the step of identifying reduction goals (step 1318) and generating recommendations (step 1320). based on the quantity and/or quality of refuse being tracked as indicated by the generated waste data. The identified reduction goals can be included in the analysis, ranking, and display provided in the electronic dashboard 206. The generated reduction recommendations can include any of the implementations discussed previously, such as those seen in FIGS. 10-12.

This identification and recommendation can be performed by the hardware or software provided by the same hardware and software used to track waste or can be provided by remote hardware or software in communication with the implemented tracking mechanism such as the remote monitoring platform discussed previously.

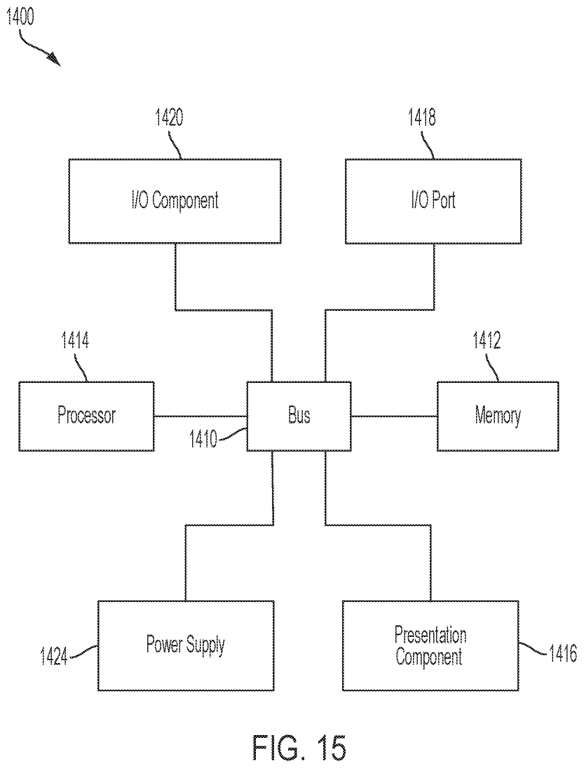

FIG. 15 depicts an example electronic or computing device 1400 that can be used to implement one or more aspects of the present invention. The functionality and hardware of such an electronic device 1400 may be implemented in the scale sensor 204, or related hardware for providing all or part of the functionality of the scale sensor, provided as a separate device to provide the electronic dashboard, or be provided in a server or other device providing the all or part of the functionality of the remote monitoring platform 604.

The electronic device 1400 is merely an illustrative example of a suitable computing environment and in no way limits the scope of the present invention. An “electronic device”, “remote device,” or “personal electronic device” as represented by FIG. 15, can include a “workstation,” a “server,” a “laptop,” a “desktop,” a “hand-held device,” a “mobile device,” a “tablet computer,” or other computing devices, as would be understood by those of skill in the art. Given that the electronic device 1400 is depicted for illustrative purposes, embodiments of the present invention may utilize any number of electronic devices 1400 in any number of different ways to implement a single embodiment of the present invention. Accordingly, embodiments of the present invention are not limited to a single electronic device 1400, as would be appreciated by one with skill in the art, nor are they limited to a single type of implementation or configuration of the example electronic device 1400.

The electronic device 1400 can include a bus 1410 that can be coupled to one or more of the following illustrative components, directly or indirectly: a memory 1412, one or more processors 1414, one or more presentation components 1416, input/output ports 1418, input/output components 1420, and a power supply 1424. One of skill in the art will appreciate that the bus 1410 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 15 is merely illustrative of an exemplary computing device that can be used to implement one or more embodiments of the present invention, and in no way limits the invention.

The computing device 1400 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1400.

The memory 1412 can include computer-storage media in the form of volatile and/or nonvolatile memory. The memory 1412 may be removable, non-removable, or any combination thereof. Exemplary hardware devices are devices such as hard drives, solid-state memory, optical-disc drives, and the like. The computing device 1400 can include one or more processors that read data from components such as the memory 1412, the various I/O components 1416, etc. Presentation component(s) 1416 present data indications to a user or other device. Exemplary presentation components include a display device, speaker, printing component, vibrating component, etc.

The I/O ports 1418 can enable the computing or electronic device 1400 to be logically coupled to other devices, such as I/O components 1420. Some of the I/O components 1420 can be built into the computing device 1400. Examples of such I/O components 1420 include a sensor (including but not limited to: weight sensor, infrared sensor, camera, chemical sensor, microphone, or the like), keypad, touchpad, joystick, recording or storage device, game pad, satellite dish, scanner, printer, wireless device, networking device, and the like.

The present invention provides a data-driven workplace waste reduction approach involving live in-building waste tracking, live data analytics, and employee engagement programs. In operation, the scale sensors 204 deployed under the different waste receptacles at one or more locations in one or more facilities, to automatically track the amount and nature of waste (trash, recycling and compost) which is thrown every day at the one or more locations. This data is collected and analyzed to produce a live, detailed analysis of the waste flow at the one or more locations. In certain embodiments, a remote monitoring platform 604 is used to track key performance indicators related to waste across the one or more locations (e.g., total waste, diversion, trash per employee, contamination rate, and the like) and enables a live ranking between teams, buildings or companies. A live dashboard is provided to the users of the system 200 to convey this data, either through screens in the building (digital signage), through dynamic dashboards accessible online, or through data access APIs.

This system is complemented with onsite and digital services meant to guide and reinforce the waste reduction efforts from the user: These services include: workplace waste audit, employee training (onsite and digitally), employee events (games/challenges), and support to identify and deploy various waste reduction initiatives (signage, layout improvement, reduce single use items, alternatives to printing etc.)

Specifically, the described approach provides a unique mechanism for automatically monitoring the daily amount of waste generated within a building, and displaying this data live in the workplace, to create stronger employee awareness and higher motivation to reduce waste. This approach also enables the creation of live games and competitions between teams, sites and companies around waste reduction.

Features of the present invention include: scale sensors deployed on or under workplace bins to track their daily waste content, recording and analysis of daily waste flow data from within a building (as opposed to measuring globally at the time of waste collection/hauling), easy to understand dashboards and visualization designed for the users, live display of dashboard (as opposed to quarterly/yearly reports), and waste reduction games, challenges and competitions between sites and companies.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

1. A system for interacting with users in collection and sorting of waste the system comprising:
one or more receptacle disposed at a first location;
one or more scale sensor associated with the one or more receptacle, configured, adapted, and positioned to measure weight, volume, or other characteristics of the one or more receptacle and its contents, the one or more scale sensor outputting real-time data;
a processor and communication port coupled with the one or more scale sensor and communicatively coupled with a computer network; and
an electronic dashboard, the electronic dashboard displaying:
a quantity and/or quality of contents in the one or more receptacle based on the data in real-time; and
a status of a competitive challenge based on the quantity of contents;
wherein the system manages one or more competitive challenges associated with users collecting and sorting waste based on the quantity and/or quality of contents in the one or more receptacle relative to one or more predetermined goals.

2. The system of claim 1, wherein the one or more receptacle comprises at least one of: a trash receptacle, a recycling receptacle, a compost receptacle.

3. The system of claim 1, wherein the scale sensor measures weight between 0 and 200 pounds plus or minus 0.2 pounds.

4. The system of claim 1, wherein the system automatically collects data at a configurable sampling rate.

5. The system of claim 1, wherein the system is in communication with a wireless network.

6. The system of claim 1, wherein the system is battery powered.

7. The system of claim 1 wherein the system is remotely managed and controlled.

8. The system of claim 1, further comprising a remote monitoring platform communicatively coupled to the computer network, the remote monitoring platform configured to receive real-time weight data from the scale sensor and generate a display for the electronic dashboard.

9. The system of claim 8, wherein the remote monitoring platform is further configured to generate reports based on the weight data received from scale sensor.

10. The system of claim 1, further comprising multiple locations each having a scale sensor associated with one or more receptacle at each location.

11. The system of claim 10, wherein the multiple locations are within a facility.

12. The system of claim 10, wherein the multiple locations are in multiple facilities.

13. The system of claim 10, wherein multiple locations are in multiple organizations.

14. The system of claim 10, wherein the one or more competitive challenges comprises competition against one or more other locations.

15. The system of claim 1, wherein status of a competitive challenge comprises collection and sorting of waste over a time period.

16. The system of claim 15, wherein status of competitive challenge comprises comparison of collection and sorting of waste from different time periods.

17. The system of claim 1, wherein the electronic dashboard further displays at least one of games, trivia, sorting tips, relevant news, and educational materials.

18. The system of claim 1, wherein the system further provides recommendations based on quantity and/or quality of contents.

19. The system of claim 1, wherein the electronic dashboard is displayed on a display provided in proximity to the location of the one or more receptacles.

20. The system of claim 1, wherein the electronic dashboard is displayed on a display of a personal electronic device.

21. The system of claim 1, further comprising one or more inputs or sensors for receiving a contamination evaluation.

22. The system of claim 21, wherein the one or more sensors or inputs comprise a personal electronic configured to receive a contamination evaluation.

23. A method of interacting with users in collection and sorting of waste, the method comprising:
providing one or more receptacle;
providing one or more scale sensor associated with the one or more receptacle, configured, adapted, and positioned to measure weight, volume, or other characteristic of the one or more receptacle and its contents, the one or more scale sensor outputting real-time data;
providing a processor and communication port coupled with the one or more scale sensor and communicatively coupled with a computer network; and
providing an electronic dashboard, the electronic dashboard displaying:
a quantity and/or quality of contents in the one or more receptacle based on the data in real-time; and
a status of a competitive challenge based on the quantity and/or quality of contents;
wherein the electronic dashboard and the processor manage one or more competitive challenges associated with users collecting and sorting waste based on the quantity and/or quality of contents in the one or more receptacle relative to one or more predetermined goals.

24-44. (canceled)

45. A method of interacting with users in collection and sorting of waste, the method comprising:
tracking waste collected at one or more receptacles deployed at one or more locations in real-time; and
providing an electronic dashboard, the electronic dashboard displaying:
a quantity of contents in the one or more receptacle in real-time; and
a status of a competitive challenge based on the quantity of contents.

46-57. (canceled)
